(19) United States
(12) Patent Application Publication
(10) Pub. No.: US 2025/0144954 A1
(43) Pub. Date: May 8, 2025

(54) SECURITY ELEMENT WITH AN OPTICAL EFFECT LAYER FORMED AS A THIN LAYER

(71) Applicant: Hueck Folien Gesellschaft m.b.H., Baumgartenberg (AT)

(72) Inventors: Stephan TRASSL, Baumgartenberg (AT); Martin EGGINGER, Linz (AT); Marco MAYRHOFER, Baumgartenberg (AT); Anita FUCHSBAUER, Linz (AT)

(21) Appl. No.: 17/754,479

(22) PCT Filed: Sep. 18, 2020
(86) PCT No.: PCT/EP2020/076082

§ 371 Date: Apr. 1, 2022

(30) Foreign Application Priority Data
Oct. 3, 2019 (EP) 19201229.2

(51) Int. Cl. B42D 25/324; B42D 25/21; B42D 25/328; B42D 25/364; B42D 25/369; B42D 25/373

(52) U.S. Cl. CPC B42D 25/324; B42D 25/21; B42D 25/328; B42D 25/364; B42D 25/369; B42D 25/373

(57) ABSTRACT

A security element with increased protection against forgery includes at least one first region with structures that reflect an image motif in different spatial regions, such that a moving image is produced for an observer when a light source is moved correspondingly and/or when the viewing angle is changed. When the light source is moved and/or the viewing angle is changed, a movement of the image motif occurs at the same time. Furthermore, an optical effect layer is provided which defines a second region. The optical effect layer is formed as a thin-layer element, wherein the structures are covered by the optical effect layer over their entire surface or partially.

### RELATED APPLICATIONS

This application is a national stage under 35 U.S.C. § 371 of International Application No. PCT/EP2020/076082, filed Sep. 18, 2020, which claims priority of European Patent Application No. 19201229.2, filed Oct. 3, 2019.

### TECHNICAL FIELD

The present disclosure relates to a security element, in particular for papers of value, security paper or security objects, such as banknotes, identification cards, credit cards, debit cards, and tickets.

### BACKGROUND

Security elements of the initially mentioned type are usually used to increase protection against forgery of papers of value or security papers, such as banknotes, identification cards, credit cards, debit cards, tickets.

It is the object of the present invention to create a security element with an increased protection against forgery.

This object is achieved by a security element of the initially mentioned type according to the present disclosure in that the security element has at least one first region with structures, and the structures reflect an image motif in different spatial regions, such that a moving image is produced for an observer when a light source is moved correspondingly and/or when a viewing angle is changed, wherein, when the light source is moved and/or the viewing angle is changed, a movement of the image motif occurs at the same time, and in this regard it is further provided
that an optical effect layer is provided, said optical effect layer defining at least one second region,
that the optical effect layer is formed as a thin-layer element, and
that the structures are covered by the optical effect layer over their entire surface or partially.

The advantage achieved thereby consists in that by a position, overlapping one another, of the first region for forming the image motif formed as a moving image and the second region for forming at least one optical appearance or one optical effect, a high combination and design variety is created. Hence, the protection against forgery of the thus formed security element is even further increased. Thus, the moving image formed by the structures is combined directly with the optical effect generated or caused by the optical effect layer to a total image. An observer of the security element can thus quickly and securely determine the authenticity by pure visual inspection without using any aids.

Moreover, it may be advantageous if the optical effect layer formed as a thin-layer element comprises at least one absorber layer and at least one spacer layer.

A further possible embodiment has the features that the at least one spacer layer is applied to, in particular printed and/or vapor-deposited on, the structures. At this point, it should be noted that the phrase a layer is applied to something is to be understood as meaning that the layer may be applied directly, or that between the applied layer and that to which the layer is applied, one or multiple intermediate layers may be present.

Furthermore, the absorber layer may be applied to, in particular printed and/or vapor-deposited on, the structures.

According to an advantageous advancement, the spacer layer and the absorber layer may be applied to the structures in the sequence of absorber layer-spacer layer or spacer layer-absorber layer.

A further embodiment provides that on both sides of the at least one spacer layer, in each case, at least one absorber layer is arranged, and that the at least one absorber layer is applied to, in particular printed and/or vapor-deposited on, the structures.

A different embodiment is characterized in that the optical effect layer formed as a thin-layer element further comprises at least one reflection layer, wherein the at least one spacer layer is arranged between the at least one absorber layer and the at least one reflection layer.

A further preferred embodiment is characterized in that the reflection layer is applied to, in particular printed and/or vapor-deposited on, the structures.

Moreover, it may be advantageous if the at least one absorber layer is applied to, in particular printed and/or vapor-deposited on, the structures.

A further embodiment provides that, when the light source is moved and/or when the viewing angle is changed, a color-shifting effect occurs in the optical effect layer formed as a color-shifting layer or in the color-shifting ply.

A different embodiment is characterized in that the security element contains metallic pigments and/or magnetic pigments and/or fluorescent pigments and/or fluorescent substances and/or color pigments and/or colorants in addition to the thin-layer element.

A further preferred embodiment is characterized in that it comprises a carrier layer of a plastic material, wherein, in particular, the plastic material is formed of a translucent and/or thermoplastic material, and that the carrier layer preferably comprises at least one of the materials from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone, (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinylcholride (PVC) ethylene tetrafluoroethylene (ETFE), polytetrafluoroethylene

(PTFE), polyvinyl fluoride (PVF),polyvinylidene fluoride (PVDF), and ethylene-tetrafluoroethylene-hexafluoropropylene-fluoropolymer (EFEP) and/or mixtures and/or copolymers of these materials or is made of at least one of these materials.

Moreover, it may be advantageous if the carrier layer has a thickness with a thickness value from a thickness value range the lower limit of which is 5 μm, preferably 10 μm, and the upper limit of which is 1000 μm, preferably 50 μm.

A different embodiment is characterized in that the at least one absorber layer comprises at least one metallic material, in particular selected from the group of nickel, titanium, vanadium, chromium, cobalt, palladium, iron, tungsten, molybdenum, niobium, aluminum, silver, copper and/or alloys of these materials or is made of at least one of these materials.

Another embodiment is characterized in that the at least one spacer layer is formed of a dielectric material.

A further possible embodiment has the features that the at least one spacer layer comprises at least one low refractive index dielectric material having a refractive index of less than or equal to 1.65, in particular selected from the group of aluminum oxide (Al₂O₃), metal fluorides, for example magnesium fluoride (MgF₂), aluminum fluoride (AlF₃), silicon oxide (SIOₓ), silicon dioxide (SiO₂), cerium fluoride (CeF₃), sodium aluminum fluorides (e.g. Na₃AlF₆ or Na₅Al₃F₁₄), neodymium fluoride (NdF₃), lanthanum fluoride (LaF₃), samarium fluoride (SmF₃) barium fluoride (BaF₂), calcium fluoride (CaF₂), lithium fluoride (LiF), low refractive index organic monomers and/or low refractive index organic polymers, or at least one high refractive index dielectric material having a refractive index of greater than 1.65, in particular selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or is made of at least one of these materials.

Another embodiment provides that the at least one reflection layer comprises at least one metallic material, in particular selected from the group of silver, copper, aluminum, gold, platinum, niobium, tin, or of nickel, titanium, vanadium, chromium, cobalt and palladium, or alloys of these materials, in particular cobalt-nickel alloys, or at least one high refractive index dielectric material having a refractive index of larger than 1.65, in particular selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), Europium oxide (Eu₂O₃), iron oxides such as iron (II,III) oxide (Fe₃O₄) and iron (III) oxide (Fe₂O₃), hafnium nitride (HfN), hafnium carbide (HfC), Hafnium oxide (HfO₂), Lanthanum oxide (La₂O₃), Magnesium oxide (MgO), Neodymium oxide (Nd₂O₃), Praseodymium oxide (Pr₆O₁₁), Samarium oxide (Sm₂O₃), Antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or is made of at least one of these materials.

Another embodiment is characterized in that the structures are formed as diffractive structures, as micromirrors, as facets with a radiation-optical effect, or as achromatic, reflective structures.

A further preferred embodiment is characterized in that the structures are inserted into the carrier layer by means of an impression device, in particular by an embossing process, or that the structures are formed in a layer, in particular an embossing lacquer layer, applied onto the carrier layer directly or with the interposition of an intermediate layer, in particular are impressed by means of an impression device.

Finally, it may be advantageous if the further layer with the structures formed therein has a layer thickness with a layer thickness value from a layer thickness value range the lower limit of which is 0.5 μm, in particular 0.8 μm, preferably 1 μm, and the upper limit of which is 300 μm, in particular 50 μm, preferably 10 μm.

According to an advancement, it is possible that the security element is equipped with further color-shifting layers, in particular layers with color-shifting pigments or liquid crystals, and/or machine-readable features, wherein the machine-readable features in particular are magnetic coding, electrically conductive layers, materials absorbing and/or remitting electromagnetic waves.

Furthermore, it can be useful if the security element comprises additional layers, said additional layers comprising in particular color lacquers, protective lacquers, adhesives, primers and/or films.

### BRIEF DESCRIPTION OF THE DRAWINGS

For the purpose of better understanding of the invention, it will be elucidated in more detail by means of the figures below.

These show in a respectively very simplified schematic representation:

FIG. 1 a section through a possible exemplary embodiment of the security element;

FIG. 2 a section through another exemplary embodiment of the security element;

FIG. 3 a first possible layer and/or ply structure of the security element in a view and stylized representation;

FIG. 4 a second possible layer and/or ply structure of the security element in a view and stylized representation;

FIG. 5 a third possible layer and/or ply structure of the security element in a view and stylized representation;

FIG. 6 a fourth possible layer and/or ply structure of the security element in a view and stylized representation;

FIG. 7 a further possible layer structure of the optical effect layer in a view and stylized representation;

### DETAILED DESCRIPTION OF EXEMPLARY EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, are to be analogously transferred to the new position.

The term “in particular” shall henceforth be understood to mean that it may refer to a possible more specific formation or more detailed specification of an object or a process step, but need not necessarily depict a mandatory, preferred embodiment of same or a mandatory practice.

The figure descriptions are intertwined and equal components or equal parts are provided with equal reference numbers. Furthermore, the term “layer” is generally used for a multi-layered, cohesive composite component. Thus, each of the layers described below may also comprise multiple layers that are preferably interconnected or adhere to one another.

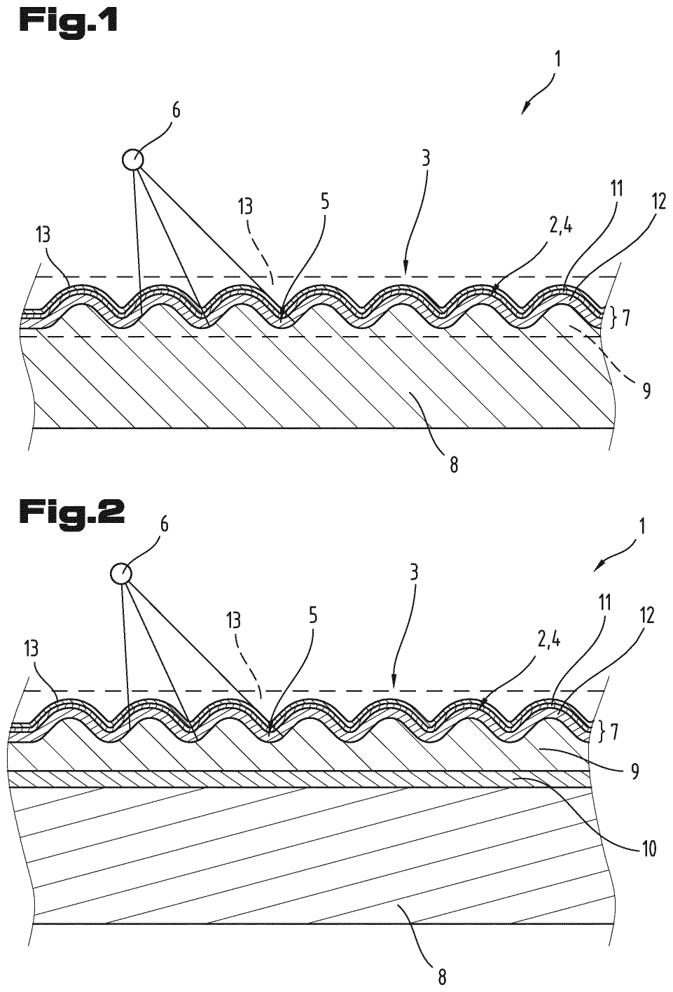

FIG. 1 shows a security element 1, in particular for papers of value, banknotes, card applications or security papers, in a highly stylized representation and not depicted to scale.

The security element 1 comprises at least one first region 2 and at least one second region 3 covering it at least in some sections. The at least one first region 2 is arranged below the second region 3 in the shown position and/or placement of the security element 1. The two regions 2, 3 and/or the layers or plies are formed differently from one another and will be described in further detail below.

The at least one first region 2 comprises structures 4 or is formed by these. By the structures 4 of the first region 2, an image motif 5 is reflected in different spatial regions, such that a so-called moving image is produced for an observer when a light source 6 is moved correspondingly and/or when a viewing angle is changed.

In this exemplary embodiment, the second region 3, which at least sectionally overlaps or superimposes the first region 2, is formed by an optical effect layer 7. The optical effect layer 7 may also be formed as an optically variable layer or be referred to as such.

The optical effect layer 7 may have or form an optically variable effect dependent on the viewing angle and/or on the lighting angle and/or on the type of lighting. The optically variable effect may be e.g. a view/see-through effect and/or a color-shifting effect and/or a fluorescence effect or the like.

In this context, it should be noted that the structures 4 may be provided partially or over the entire surface. This also applies to the optical effect layer 7, which may also be provided partially or over the entire surface. The optical effect layer 7 may also be formed of or comprise multiple layers.

The security element 1 may also comprise a carrier layer 8. The carrier layer 8 may be formed of a plastic material. Moreover, it is also possible that multiple layers form the carrier layer 8. The plastic may be formed of a translucent and/or thermoplastic material. The material for the carrier layer 8, can comprise at least one of the materials from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone, (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinylcholride (PVC) ethylene tetrafluoroethylene (ETFE), polytetrafluoroethylene (PTFE), polyvinyl fluoride (PVF),polyvinylidene fluoride (PVDF), and ethylene-tetrafluoroethylene-hexafluoropropylene-fluoropolymer (EFEP) and/or mixtures and/or copolymers of these materials or can be made of at least one of these materials.

The carrier layer 8 can, in turn, have a thickness with a thickness value from a thickness value range the lower limit of which is 5 μm, preferably 10 μm, and the upper limit of which is 1000 μm, preferably 50 μm.

The structures 4 described above can be formed, for example, as diffractive structures, as micromirrors, as facets with a radiation-optical effect, or as achromatic, reflective structures. The formation of the structures 4 as a diffractive structures has become known, for example from EP2782765B1, EP2885135B1 and WO2015107347A1. An embodiment of the structures 4 as micromirrors is known to the person skilled in the art e.g. from U.S. Pat. No. 10,189,294A1 as well as EP3362827A1. A facet-like formation of the structures 4 results, for example from EP2632739A1. Moreover, the structures 4 can have been or be inserted into the carrier layer 8 by means of an impression device, in particular by an embossing process.

A further alternative possibility would be to provide a separate further layer 9 for forming the structures 4. The further layer 9 may be applied directly to the carrier layer 8. The further layer 9 is indicated by a dashed line. Hence, e.g., the further layer 9 may be formed by an embossing lacquer which is deformed according to the formation of the structures 4. This can, in turn, be performed by means of the impression device or an impression element in an embossing process. Thus, in turn, the structures 4 can be formed. The further layer 9 with the structures 4 formed therein may have a layer thickness with a layer thickness value from a layer thickness value range the lower limit of which is 0.5 μm, in particular 0.8 μm, preferably 1 μm, and the upper limit of which is 300 μm, in particular 50 μm, preferably 20 μm.

FIG. 2 additionally shows that the structures 4 are formed by the further layer 9, however, the further layer 9 is not applied directly to the carrier layer 8. For this purpose, an intermediate layer 10 can be provided, which is formed, for example, by an adhesion promoter, a primer, an adhesive, or the like.

The structures 4 can be formed, for example, as diffractive structures, as micromirrors, as facets with a radiation-optical effect, or as achromatic, reflective structures. The formation and/or the insertion of the structures 4 directly in the carrier layer 8 may be carried out, e.g. by means of an impression device, in particular by means of an embossing process.

If the further layer 9 described above is provided for forming the structures 4, these can be formed in the further layer 9 applied to the carrier layer 8. The further layer 9 may be formed in particular of an embossing lacquer layer. The introduction or molding of the structures 4 may, again, be carried out e.g. by means of an impression device, in particular by means of an embossing process.

In the exemplary embodiments shown, the structures 4 form the at least one first region 2 of the security element 1, wherein the at least one first region 2 is covered or superimposed at least in some sections by the at least one second region 3. The at least one second region 3 is formed by the optical effect layer 7, which, in all exemplary embodiments, is formed as a so-called thin-layer element, which has a thin-layer-structure or may itself be referred to as thin-layer-structure. The layer thickness of the individual layers or plies forming the thin-layer element is shown in a greatly exaggerated manner and not depicted to scale. Thus, the structures 4 can be covered by the optical effect layer 7 over their entire surface or partially.

The optical effect layer 7 formed as a thin-layer element comprises at least one absorber layer 11 and at least one spacer layer 12. Further possible additional layers of the optical effect layer 7 are described in the figures below.

The at least one absorber layer 11 may comprise at least one metallic material, in particular selected from the group of nickel, titanium, vanadium, chromium, cobalt, palladium, iron, tungsten, molybdenum, niobium, aluminum, silver, copper and/or alloys of these materials or be made of at least one of these materials.

The at least one spacer layer 12 may be formed, e.g. from a dielectric material. Furthermore, the at least one spacer layer 12 may comprise at least one low refractive index dielectric material having a refractive index of less than or equal to 1.65, in particular selected from the group of aluminum oxide (Al₂O₃), metal fluorides, for example magnesium fluoride (MgF₂), aluminum fluoride (AlF₃), silicon oxide (SIOₓ), silicon dioxide (SiO₂), cerium fluoride (CeF₃), sodium aluminum fluorides (e.g. Na₃AlF₆ or Na₅Al₃F₁₄), neodymium fluoride (NdF₃), lanthanum fluoride (LaF₃), samarium fluoride (SmF₃) barium fluoride (BaF₂), calcium fluoride (CaF₂), lithium fluoride (LiF), low refractive index organic monomers and/or low refractive index organic polymers, or at least one high refractive index dielectric material having a refractive index of greater than 1.65, in particular selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or be made of at least one of these materials.

The optical effect layer 7 formed as a thin-layer element is always arranged on or applied to the structures 4. It is possible to apply the entire thin-layer element as an optical effect layer 7 to the structures 4. However, it would also be possible to apply individual layers or plies of the optical effect layer 7 subsequently or also in a grouped manner. The application of the optical effect layer 7 or of individual layers or plies of the same can be carried out in a variety of methods, depending on the selected material. Printing and/or vapor-deposition and/or lacquering are cited as possible examples.

It would additionally also be possible to provide a separate intermediate layer 10, such as an adhesion promoter layer or an adhesion promoter ply, a primer layer or primer ply or the like, between the structures 4 forming the first region 2 and the optical effect layer 7 with its second region 3. Thereby, the arrangement or application of the optical effect layer 7 on the structures 4 can take place either directly and/or with the interposition of the separate, additional intermediate layer 10.

In addition to the optical effect layer 7 formed as a thin-layer element, further layers may be provided, for example an optically non-linear layer or an optically non-linear ply. Such a layer or such materials or plies forming this layer are also referred to as IR upconverters or UV downconverters. In this regard, these may be materials which, under the influence of electromagnetic radiation outside the visible wavelength range of light, have a visible color. Such materials can be excited to emit visible light under these conditions, for example, when exposed to infrared (IR) (λ>780 nm) and/or ultraviolet (UV) light (λ<380).

Moreover, the optical effect layer 7 formed as a thin-layer element may also be formed as a color-shifting layer or comprise a color-shifting ply. Any desired variations of the optical effects are also possible by means of corresponding combinations of a variety of layers and plies. Thus, it becomes possible that, e.g. when the light source 6 is moved and/or when the viewing angle is changed, a color-shifting effect occurs in the optical effect layer 7 formed as a color-shifting layer or in the color-shifting ply.

Moreover, metallic pigments and/or magnetic pigments and/or fluorescent pigments and/or fluorescent substances and/or color pigments and/or colorants may be provided in addition to the optical effect layer 7.

In the exemplary embodiment shown in FIG. 1, the at least one spacer layer 12 is applied to, in particular printed and/or vapor-deposited on, the structures 4. As described above, the at least one spacer layer 12 may be applied directly and immediately to the structures 4, or the interposition of the separate intermediate layer 10 may be provided.

As the topmost ply or layer, a protective layer 13 may be applied to the optical effect layer 7. The protective layer 13 may be provided, however, it does not have to be provided. Preferably, by means of the protective layer 13, a planar formation of the security element 1 may be achieved, as is indicated by a dashed line in FIG. 1.

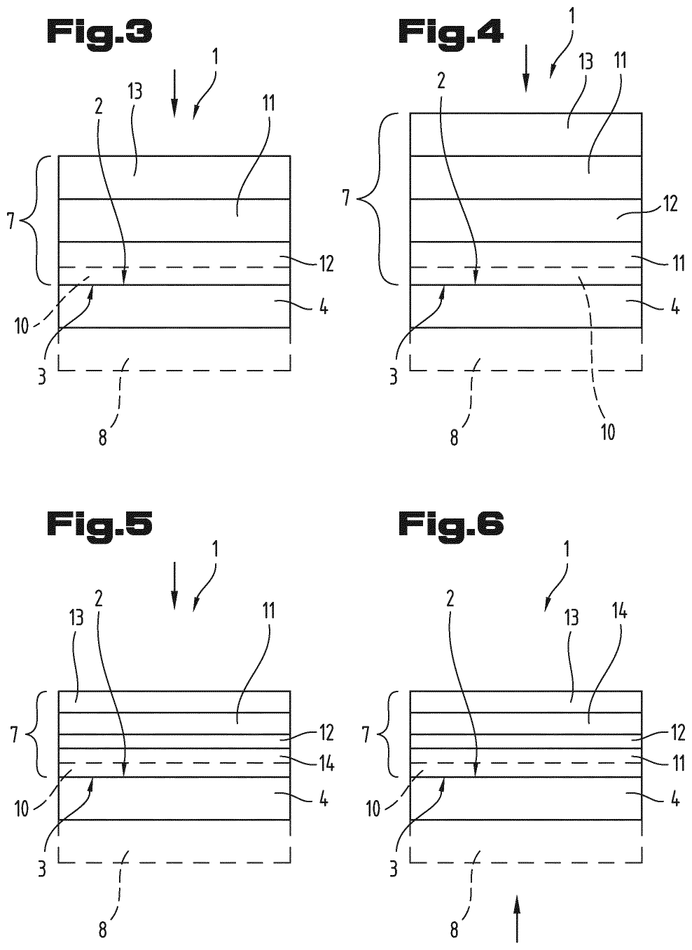

FIG. 3 additionally shows the formation of the security element 1 described above in a simplified manner. The viewing direction toward the security element 1 is adumbrated by an arrow and goes through the optical effect layer 7 onto the structures 4.

The structures 4, which define the first region 2, are covered by the second region 3 of the optical effect layer 7. The optical effect layer 7 formed as a thin-layer element comprises the spacer layer 12 facing the structures 4 as well as the absorber layer 11 above it. As a possible additional layer or ply, the protective layer 13 is additionally adumbrated on the side of the absorber layer 11 facing away from the structures 4. The protective layer 13 may be provided, however, it does not have to be provided. Moreover, the carrier layer 8 is adumbrated, wherein the structures 4 may be formed either directly on the carrier layer 8, or the further layer 9 described above may be provided, and the structures 4 may be formed on thereon.

FIG. 4 shows a possible further exemplary embodiment of the security element 1. The security element 1 has a similar layer structure to the security element 1 previously described in FIG. 3. The viewing direction toward the security element 1 is also adumbrated by an arrow and goes through the optical effect layer 7 onto the structures 4.

The structures 4, which define the first region 2, are covered by the second region 3 of the optical effect layer 7. The optical effect layer 7 formed as a thin-layer element comprises the absorber layer 11 facing the structures 4, after that the spacer layer 12, and again, the absorber layer 11 above it. Thus, at least one absorber layer 11 each is arranged or provided on both sides of the spacer layer 12. The absorber layer 11 situated closer to the structures 4 is therefore applied to or arranged on the structures 4. This may take place in a direct manner or also with the interposition of the separate intermediate layer 10.

As a possible additional layer or ply, the protective layer 13 is additionally adumbrated on the side of the outer absorber layer 11 facing away from the structures 4. The protective layer 13 may be provided, however, it does not have to be provided. Moreover, the carrier layer 8 is adumbrated, wherein the structures 4 may be formed either directly on the carrier layer 8, or the further layer 9 described above may be provided, and the structures 4 may be formed on thereon.

FIG. 5 shows a further possible exemplary embodiment of the security element 1 with its optical effect layer 7. The viewing direction toward the security element 1 is also adumbrated by an arrow and goes through the optical effect layer 7 onto the structures 4 in this case, as well.

In this regard, the general structure of the security element 1 corresponds to that which has been shown and described in FIGS. 1 and 3. As an additional layer, the optical effect layer 7 also comprises at least one reflection layer 14. In this regard, the at least one spacer layer 12 is arranged between the at least one absorber layer 11 and the at least one reflection layer 14. In this case, the reflection layer 14 is applied to or arranged on the structures 4 and may, in particular, be printed and/or vapor-deposited on them.

The at least one reflection layer 14 may comprise at least one metallic material, in particular selected from the group of silver, copper, aluminum, gold, platinum, niobium, tin, or of nickel, titanium, vanadium, chromium, cobalt and palladium, or alloys of these materials, in particular cobalt-nickel alloys, or at least one high refractive index dielectric material having a refractive index of larger than 1.65, in particular selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or be made of at least one of these materials. This applies to all reflection layers 14 described in the exemplary embodiments.

The structures 4, which define the first region 2, are covered by the second region 3 of the optical effect layer 7. Here, the optical effect layer 7 formed as a thin-layer element comprises the reflection layer 14 facing the structures 4, after that the spacer layer 12, and again, the absorber layer 11 above it. By arranging or applying the reflection layer 14 to the structures 4, it can reproduce the spatial shape of the structures 4 upon viewing. The reflection layer 14 may be applied to or arranged on the structures 4 in a direct manner or also with the interposition of the separate intermediate layer 10.

As a possible additional layer or ply, the protective layer 13 is additionally adumbrated on the side of the outer absorber layer 11 facing away from the structures 4. The protective layer 13 may be provided, however, it does not have to be provided. Moreover, the carrier layer 8 is adumbrated, wherein the structures 4 may be formed either directly on the carrier layer 8, or the further layer 9 described above may be provided, and the structures 4 may be formed on thereon.

FIG. 6 shows a further possible exemplary embodiment of the security element 1 with its optical effect layer 7. The viewing direction toward the security element 1 is also adumbrated by an arrow and, in contrast to the exemplary embodiment described above, goes through the structures 4 onto the optical effect layer 7.

The optical effect layer 7 formed as a thin-layer element comprises, starting from the side facing away from the structures 4 in the direction towards the structures 4, at least the reflection layer 14, the spacer layer 12 and subsequently the absorber layer 11. The absorber layer 11 situated closer to the structures 4 is applied to or arranged on the structures 4. This may take place in a direct manner or also with the interposition of the separate, additional intermediate layer 10.

As a possible additional layer or ply, the protective layer 13 is additionally adumbrated on the side of the, in this case, outer reflection layer 14 facing away from the structures 4. The protective layer 13 may be provided, however, it does not have to be provided. Moreover, the carrier layer 8 is adumbrated, wherein the structures 4 may be formed either directly on the carrier layer 8, or the further layer 9 described above may be provided, and the structures 4 may be formed on thereon.

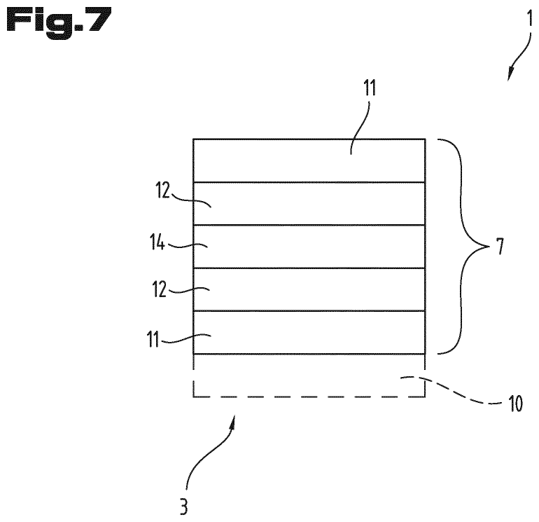

FIG. 7 shows only one possible layer structure of the optical effect layer 7 formed as a thin-layer element. In this exemplary embodiment, a layer structure of the optical effect layer 7 similar to that in FIG. 5 was chosen.

The optical effect layer 7 comprises at least the absorber layer 11, the spacer layer 12, the reflection layer 14, a further spacer layer 12, and finally, a further absorber layer 11. The two absorber layers 11 are arranged on sides of the optical effect layer 7 facing away from one another. The reflection layer 14, in turn, is arranged between the two spacer layers 12. One of the two absorber layers 11, in turn, is arranged on or applied to the structures 4. To provide a better overview, the structures 4 as well as further possible layers or plies are not shown in more detail or are only adumbrated, however, they are described below.

As a possible additional layer or ply, the protective layer 13 can additionally be arranged or provided on the side of the outer absorber layer 11 facing away from the structures 4. The protective layer 13 may be provided, however, it does not have to be provided. The structures 4 may either be formed directly on the carrier layer 8, or the further layer 9 described above may be provided and the structures 4 may be formed thereon.

For bonding the optical effect layer 7 with the structures 4, the intermediate layer 10 described above, which is adumbrated in dashed lines, may again be provided. By means of the optical effect layer 7 shown here and formed as a thin-layer element, again in combination with the structures 4, the security element 1 can be formed.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

1. A security element for papers of value, security paper or security objects, such as banknotes, identification cards, credit cards, debit cards, and tickets, comprising:
at least one first region with structures, and the structures reflect an image motif in different spatial regions, such that a moving image is produced for an observer when a light source is moved correspondingly and/or when a viewing angle is changed, wherein, when the light source is moved and/or the viewing angle is changed, a movement of the image motif occurs at the same time; and wherein:
an optical effect layer is provided, said optical effect layer defining at least one second region,
the optical effect layer is formed as a thin-layer element, and the structures are covered by the optical effect layer over their entire surface or partially.

2. The security element according to claim 1, wherein the optical effect layer formed as a thin-layer element comprises at least one absorber layer and at least one spacer layer.

3. The security element according to claim 2, wherein the at least one spacer layer and/or the at least one spacer layer is applied to, in particular printed and/or vapor-deposited on, the structures, so that a sequence structures—spacer layer—absorber layer, or a sequence structures—absorber layer—spacer layer occurs.

4. The security element according to claim 2, wherein on both sides of the at least one spacer layer, in each case, at least one absorber layer is arranged, and that the at least one absorber layer is applied to, in particular, printed and/or vapor-deposited on, the structures.

5. The security element according to claim 2, wherein the optical effect layer formed as a thin-layer element further comprises at least one reflection layer, wherein the at least one spacer layer is arranged between the at least one absorber layer and the at least one reflection layer.

6. The security element according to claim 5, wherein the reflection layer is applied to, in particular printed and/or vapor-deposited on, the structures.

7. The security element according to claim 5, wherein the at least one absorber layer is applied to, in particular printed and/or vapor-deposited on, the structures.

8. The security element according to claim 1, wherein, in addition to the optical effect layer formed as a thin-layer element, an optically non-linear layer or an optically non-linear ply is present.

9. The security element according to claim 1, wherein the optical effect layer formed as a thin-layer element is formed as a color-shifting layer or comprises a color-shifting layer.

10. The security element according to claim 9, wherein, when the light source is moved and/or when the viewing angle is changed, a color-shifting effect occurs in the optical effect layer formed as a color-shifting layer or in the color-shifting ply.

11. The security element according to claim 1, wherein it contains metallic pigments and/or magnetic pigments and/or fluorescent pigments and/or fluorescent substances and/or color pigments and/or colorants in addition to the optical effect layer.

12. The security element according to claim 1, further comprising a carrier layer of a translucent plastic material and/or a thermoplastic material, and that the carrier layer comprises at least one of the materials from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone, (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinylcholride (PVC) ethylene tetrafluoroethylene (ETFE), polytetrafluoroethylene (PTFE), polyvinyl fluoride (PVF), polyvinylidene fluoride (PVDF), and ethylene-tetrafluoroethylene-hexafluoropropylene-fluoropolymer (EFEP) and/or mixtures and/or copolymers of these materials or is made of at least one of these materials.

13. The security element according to claim 12, wherein the carrier layer has a thickness with a thickness value from a thickness value range the lower limit of which is 5 μm, and the upper limit of which is 1000 μm.

14. The security element according to claim 2, wherein the at least one absorber layer comprises at least one metallic material selected from the group of nickel, titanium, vanadium, chromium, cobalt, palladium, iron, tungsten, molybdenum, niobium, aluminum, silver, copper and/or alloys of these materials or is made of at least one of these materials.

15. The security element according to , claim 2, wherein the at least one spacer layer is formed of a dielectric material.

16. The security element according to claim 2, wherein the at least one spacer layer comprises at least one low refractive index dielectric material having a refractive index of less than or equal to 1.65 and selected from the group of aluminum oxide (Al₂O₃), metal fluorides, for example magnesium fluoride (MgF₂), aluminum fluoride (AlF₃), silicon oxide (SIOₓ), silicon dioxide (SiO₂), cerium fluoride (CeF₃), sodium aluminum fluorides (e.g. Na₃AlF₆ or Na₅Al₃F₁₄), neodymium fluoride (NdF₃), lanthanum fluoride (LaF₃), samarium fluoride (SmF₃) barium fluoride (BaF₂), calcium fluoride (CaF₂), lithium fluoride (LiF), low refractive index organic monomers and/or low refractive index organic polymers, or at least one high refractive index dielectric material having a refractive index of greater than 1.65, in particular selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or is made of at least one of these materials.

17. The security element according to claim 6, wherein the at least one reflection layer comprises at least one metallic material selected from the group of silver, copper, aluminum, gold, platinum, niobium, tin, or of nickel, titanium, vanadium, chromium, cobalt and palladium, or alloys of these materials, or at least one high refractive index dielectric material having a refractive index of larger than 1.65 and selected from the group of zinc sulfide (ZnS), zinc oxide (ZnO), titanium dioxide (TiO₂), carbon (C), indium oxide (In₂O₃), indium tin oxide (ITO), tantalum pentoxide (Ta₂O₅), cerium oxide (CeO₂), yttrium oxide (Y₂O₃), europium oxide (Eu₂O₃), iron oxides such as iron (II,III) oxide (Fe₃O₄) and iron (III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), high refractive index organic monomers and/or high refractive index organic polymers, or is made of at least one of these materials.

18. The security element according to claim 1, wherein the structures are formed as diffractive structures, as micromirrors, as facets with a radiation-optical effect, or as achromatic, reflective structures.

19. The security element according to claim 13, wherein the structures are inserted into the carrier layer by means of an impression device, in particular by an embossing process, or that the structures are formed in a layer, in particular an embossing lacquer layer, applied onto the carrier layer directly or with the interposition of an intermediate layer, in particular are impressed by means of an impression device.

20. The security element according to claim 19, wherein the further layer with the structures formed therein has a layer thickness with a layer thickness value from a layer thickness value range the lower limit of which is 0.5 μm, in particular 0.8 μm, preferably 1 μm, and the upper limit of which is 300 μm, in particular 50 μm, preferably 20 μm.

21. The security element according to claim 1, wherein the security element is equipped with further color-shifting layers, in particular layers with color-shifting pigments or liquid crystals, and/or with machine-readable features, wherein the machine-readable features in particular are magnetic coding, electrically conductive layers, materials absorbing and/or remitting electromagnetic waves.

22. The security element according to claim 1, wherein the security element has additional layers, said additional layers comprising in particular protective lacquers, heat-sealing lacquers, adhesives, primers and/or films.
